(19) United States
(12) Patent Application Publication
(10) Pub. No.: US 2020/0109697 A1
(43) Pub. Date: Apr. 9, 2020

(54) PANEL SYSTEM FOR COLLECTING RENEWABLE ENERGY

(71) Applicant: Mark Kenneth Finlayson, Schwenksville, PA (US)

(72) Inventor: Mark Kenneth Finlayson, Schwenksville, PA (US)

(21) Appl. No.: 16/155,064

(22) Filed: Oct. 9, 2018

(51) Int. Cl. F03D 9/46; F03D 3/04; F03D 9/00; F03D 3/00

(52) U.S. Cl. CPC F03D 9/46; F03D 3/04; F03D 9/007; F05B 2260/42; F05B 2220/30; F05B 2240/13; F03D 3/002

(57) ABSTRACT

A renewable energy collection device including at least one panel configured to secure to a road barrier. The panel includes at least one wind collection vent defining an opening on an outer surface of the panel. The panel further includes an air channel defined within the panel and fluidly connected to the wind collection vent. A wind turbine is rotatably coupled within the panel and is positioned to receive wind flowing through the air channel. An electrical connector electrically connects to the wind turbine and is operable to connect with at least one of an electrical power collector and a power grid.

### BACKGROUND OF THE INVENTION

The present invention relates to renewable energy collection and, more particularly, to a panel system for road barriers that collect renewable energy and convert the renewable energy to electricity.

Every second, tremendous amounts of wind energy created by moving cars is wasted. In addition, solar energy radiating onto jersey barriers is not collected and utilized.

As can be seen, there is a need for a panel system for road barriers that collect renewable energy and convert the renewable energy to electricity.

### SUMMARY OF THE INVENTION

In one aspect of the present invention, a renewable energy collection device comprises: at least one panel configured to be secured to a barrier, the at least one panel comprising: at least one wind collection vent defining an opening on an outer surface of the at least one panel; an air channel defined within the panel and fluidly connected to the at least one wind collection vent; and a wind turbine positioned to receive wind flowing through the air channel, and an electrical connector electrically connected to the wind turbine and operable to connect with at least one of an electrical power collector and a power grid.

In another aspect of the present invention, a method of collecting renewable energy comprises steps of: mounting at least one panel to a road barrier, wherein the at least one panel comprises: at least one wind collection vent defining an opening on an outer surface of the at least one panel, wherein the opening is facing a road; an air channel defined within the panel and fluidly connected to the at least one wind collection vent; and a wind turbine positioned to receive wind flowing through the air channel, and electrically connecting the wind turbine to at least one of an electrical power collector and a power grid.

These and other features, aspects and advantages of the present invention will become better understood with reference to the following drawings, description and claims.

### BRIEF DESCRIPTION OF THE DRAWINGS

FIG. 1 is a schematic top view of an embodiment of the present invention;

FIG. 2 is a schematic side view of an embodiment of the present invention;

FIG. 3 is schematic end view of an embodiment of the present invention; and

FIG. 4 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes green jersey barrier that collects wind and solar energy to produce electricity. The green jersey barrier is designed to be added to the sides and top of pre-existing jersey barriers. The wind vents disposed at both sides of the barrier collect and funnel air from passing cars and trucks upward and into air collection channels. This air continues down each air collection channel, over a wind turbine, and then continues onto the wind channel of the next green jersey barrier. As the wind turbine rotates from the passing air, the wind turbine generates electricity that is transferred via electrical wire to the conduits located in each air collection channel and connects to the electrical wire that transfers the electricity from barrier to barrier.

A solar ribbon may be attached to the entire width and length of the top connector cover, which provides 9 sq. feet of solar collection surface area for the normal highway jersey barrier. Electrical wire is connected from the solar ribbon and fished through the top connector cover into the conduit where it is connected to electrical wire that runs through the conduits from barrier to barrier and ultimately terminates in an energy collection device. The green jersey barrier is designed to transfer the wind energy from barrier to barrier via the air collection channels that can be connected between barriers. Likewise, the electricity created by both the solar ribbon and wind turbine are connected to copper wire that links between barriers within the conduit. This easily allows for the electricity to be transferred extensive distances and ultimately collected in a device like a charging station.

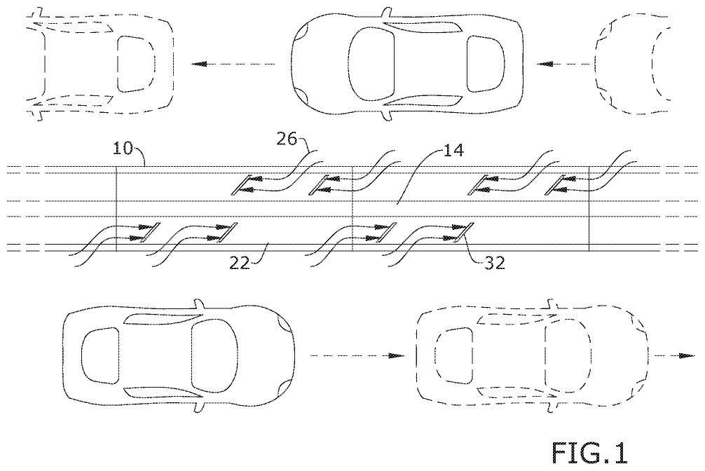

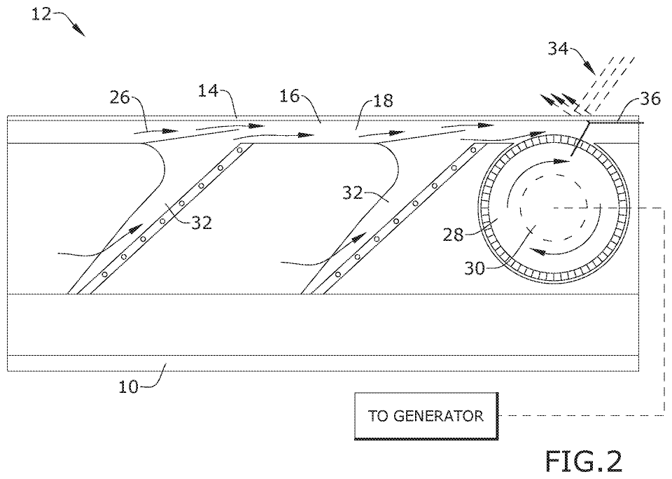

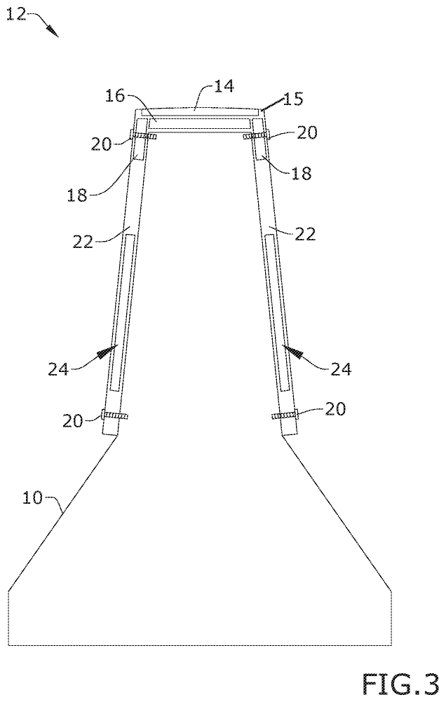

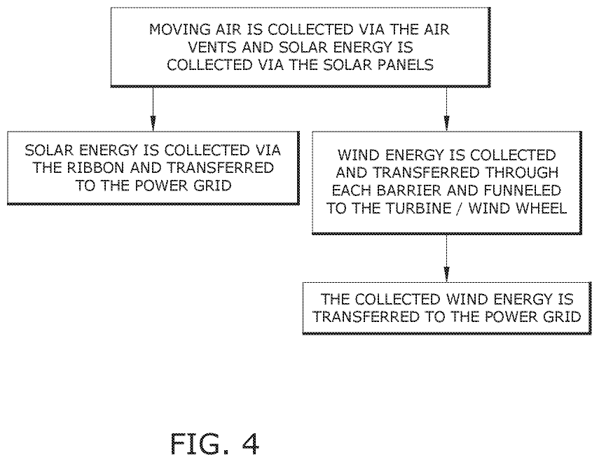

Referring to FIGS. 1 through 4, the present invention includes a renewable energy collection device 12. The collection device 12 includes at least one panel 22 configured to secure to a road barrier 10 (jersey wall). For example, bolts 20 may be used to secure the panels 22 to the road barrier 10. The panel 22 includes at least one wind collection vent 24 defining an opening 32 on an outer surface of the panel 22. The panel 22 further includes an air channel 18 defined within the panel 22 and fluidly connected to the wind collection vent 24. A wind turbine 30 is rotatably coupled within the panel 22 and is positioned to receive wind 26 flowing through the air channel 18. An electrical connector 36 electrically connects to the wind turbine 30 and is operable to connect with at least one of an electrical power collector (battery) and a power grid.

The present invention may include a plurality of panels 22. Each of the plurality of panels 22 further include an entrance to the air channel 18 at a first end and an exit to the air channel 18 at a second end opposite the first end. The plurality of panels 22 are mounted consecutively to the road barrier 10 such that the entrances and the exits are fluidly connected. Therefore, wind 26 traveling into the wind collection vent 24 of one of the panels 22 travels into the air channel 18, through the wind turbine 30, and into another of the panels 22.

In certain embodiments, each of the panels 22 may include a plurality of wind collection vents 24 each fluidly connected to the air channel 18. The wind collection vents 24 may be angled relative to the air channel 18 and towards the wind turbine 30. In such embodiments, the air channel 18 may be disposed at the top end of the panels 22. The fins 28 of the wind turbine 30 protrude into the air channel 18 adjacent to and before the exit.

The present invention may include a plurality of top panels 15. The top panels 15 each include conduits 16 aligned with one another when secured to the road barrier 10 consecutively. The electrical connectors 36 may be an electrical wiring that runs through the conduits 16. The top panels 15 may be mounted to the tops of the road barrier 10. The top panels 15 covers both the barrier top and the width of both air channels 18. The present invention may further include a plurality of solar ribbons 14 coupled to the plurality of top panels 15 and electrically connected to the electrical wiring. The solar ribbons 14 may be attached to the entire width and length of the top panels 15. The solar ribbons 14 convert solar energy 34 to electricity. The electrical wiring is connected to the solar ribbon 14 and directed into the conduits 16.

The collection device 12 is designed to be added to the sides and top of pre-existing road barriers 10. The wind collection vents 24 are disposed on either side of the barrier 10 to collect and funnel air from passing cars and trucks upward and into the air channels 18. This air continues down each air channel 18, over the wind turbine 30, and then continues onto the air channel 18 of the next collection device 12. As the wind turbine 30 rotates from the passing air, electricity is generated and transferred via copper wire that transfers the electricity from collection device 12 to collection device 12. The solar ribbon 14 may provide 9 sq. feet of solar collection surface area for the normal highway road barrier 10. Copper transfer cable is connected from the solar ribbon 14 and fished through the top panel 15 cover into the conduit 16 where it is connected to a copper wire that runs through the conduits 16 from barrier to barrier and ultimately terminates in an energy collection device. The green jersey barrier is designed to transfer the wind energy from barrier to barrier via the air channels 18 that can be connected between barriers. Likewise, the electricity created by both the solar ribbon 14 and wind turbine 30 are connected to copper wire that links between barriers within the conduit 16. This easily allows for the electricity to be transferred extensive distances and ultimately collected in a device like a battery or the electric power grid.

To use this invention, one would attach the pre-manufactured and an assembled onto pre-existing or new jersey barriers. The top panel (with solar ribbon), air connection channel, and conduit are prebuilt as one solid state part that can be attached to a jersey barrier with concrete screws. Holes for the air intake, wind turbine, and copper cabling are also added during the pre-manufacturing process (though additional cuts can be made in the filed as needed). The panels are attached to the sides of the barriers with concrete screws and the top panels attaches to the air connection channel at the predetermined intake slots. A plastic connector clamp is used to connect each panel to the next one. Copper transfer wires are attached from the solar ribbon and the wind turbine and then connected to a copper transfer wire that runs through the conduit from barrier to barrier.

It should be understood, of course, that the foregoing relates to exemplary embodiments of the invention and that modifications may be made without departing from the spirit and scope of the invention as set forth in the following claims.

What is claimed is:

1. A renewable energy collection device comprising:
at least one panel configured to be secured to a barrier, the at least one panel comprising:
at least one wind collection vent defining an opening on an outer surface of the at least one panel;
an air channel defined within the panel and fluidly connected to the at least one wind collection vent; and
a wind turbine positioned to receive wind flowing through the air channel, and
an electrical connector electrically connected to the wind turbine and operable to connect with at least one of an electrical power collector and a power grid.

2. The renewable energy collection device of claim 1, wherein the at least one panel comprises a plurality of panels, wherein each of the plurality of panels further comprise an entrance to the air channel at a first end and an exit to the air channel at a second end opposite the first end, wherein when the panels are secured to the barrier consecutively, the entrances and the exits are fluidly connected.

3. The renewable energy collection device of claim 2, wherein fins of the wind turbine protrude into the air channel adjacent to and before the exit.

4. The renewable energy collection device of claim 1, wherein the at least one wind collection vent comprises a plurality of wind collection vents each fluidly connected to the air channel.

5. The renewable energy collection device of claim 2, further comprising a plurality of top panels each comprising conduits aligned with one another when secured to the barrier consecutively, wherein the electrical connector is an electrical wiring that runs through the conduits.

6. The renewable energy collection device of claim 5, further comprising a plurality of solar ribbons coupled to the plurality of top panels and electrically connected to the electrical wiring.

7. The renewable energy collection device of claim 1, wherein the at least one wind collection vent is angled relative to the air channel and towards the wind turbine.

8. The renewable energy collection device of claim 1, wherein the wind turbine is rotatably coupled within the at least one panel.

9. A method of collecting renewable energy comprising steps of:
mounting at least one panel to a road barrier, wherein the at least one panel comprises:
at least one wind collection vent defining an opening on an outer surface of the at least one panel, wherein the opening is facing a road;
an air channel defined within the panel and fluidly connected to the at least one wind collection vent; and
a wind turbine positioned to receive wind flowing through the air channel, and
electrically connecting the wind turbine to at least one of an electrical power collector and a power grid.

10. The method of claim 9, wherein the at least one panel comprises a plurality of panels, wherein each of the plurality of panels further comprise an entrance to the air channel at a first end and an exit to the air channel at a second end opposite the first end.

11. The method of claim 9, further comprising a step of mounting the plurality of panels to the road barrier consecutively such that the entrances and the exits are fluidly connected.
